(19) United States
(12) Patent Application Publication
(10) Pub. No.: US 2013/0074598 A1
(43) Pub. Date: Mar. 28, 2013

(54) INERTIAL SENSOR

(71) Applicants: Heung Woo Park, Gyunggi-do (KR); Min Kyu Choi, Incheon (KR)

(72) Inventors: Heung Woo Park, Gyunggi-do (KR); Min Kyu Choi, Incheon (KR)

(73) Assignee: SAMSUNG ELECTRO-MECHANICS CO., LTD., Gyunggi-do (KR)

(21) Appl. No.: 13/325,177

(22) Filed: Dec. 14, 2011

(30) Foreign Application Priority Data
Sep. 22, 2011 (KR) 1020110095788

(51) Int. Cl. G01P 15/08

(52) U.S. Cl. 73/514.16

(57) ABSTRACT

Disclosed herein is an inertial sensor including: a sensor part including a driving body, a flexible substrate part displaceably supporting the driving body, a support part supporting the flexible substrate part so that the driving body is freely movable in a state in which it is floated, and a lower cap covering a lower portion of the driving body and coupled to the support part; an application specific integrated circuit (ASIC) including the sensor part stacked thereon and coupled thereto; a printed circuit board including the ASIC stacked thereon and coupled thereto and electrically connected to the sensor part and the ASIC by a wire; and a cap covering the sensor part and the ASIC and coupled to the printed circuit board, wherein the cap includes an air discharging hole formed in order to discharge internal air to the outside.

### CROSS REFERENCE TO RELATED APPLICATION

This application claims the benefit of Korean Patent Application No. 10-2011-0095788, filed on Sep. 22, 2011, entitled “Inertial Sensor”, which is hereby incorporated by reference in its entirety into this application.

### BACKGROUND OF THE INVENTION

1. Technical Field

The present invention relates to an inertial sensor.

2. Description of the Related Art

Generally, an inertial sensor measuring acceleration and/or angular velocity has been widely used while being mounted in a motion remote controller for screen conversion of a mobile phone, a game, and a digital TV, a remote controller of a game machine, and a sensor module for sensing hand shaking and sensing a position and an angle of motion, or the like.

In addition, the inertial sensor senses motion as acceleration or angular velocity and converts the sensed information into an electrical signal. Therefore, when a device is operated by using a user's motion as an input, it is possible to implement a motion interface. In addition, the inertial sensor has been widely used in a navigation and control sensor of an airplane and a vehicle, in addition to a motion sensor such as home appliances, or the like.

Further, as the inertial sensor is used for a portable PDA, a digital camera, or a mobile phone, or the like, a need exists for a technology capable of implementing a compact and light inertial sensor with various functions. As a result, a development of a micro-sensor module has been demanded.

In addition, an inexpensive and micro-inertial sensor for a personal portable product has mainly used a capacitive type and a type using a piezoelectric element. A driving unit of the inertial sensor may be sorted into a piezo-electric type and a capacitive type and a sensing unit thereof may be sorted into a piezo-electric type, a capacitive type, and a piezoresistive type.

Further, in the case of an inertial sensor using a piezoelectric element among the inertial sensors according to the prior art, a silicon structure includes a driving body, a flexible substrate part, and a support part, wherein the flexible substrate part is provided with a vibrating electrode and a sensing electrode, current is applied to the vibrating electrode to thereby drive the driving body, and the sensing electrode senses displacement of the driving body due to the driving of the driving body.

In addition, the inertial sensor using a piezoelectric element does not require vacuum packaging and may be implemented through atmospheric pressure packaging in contrast with the capacitive type inertial sensor. Therefore, after a silicon structure element is mounted on a lead frame, an epoxy molding compound (EMC) molding process filling the surrounding of the element with epoxy is performed. However, in order to perform the EMC molding process, an upper cap for protecting the silicon structure element should be included. In addition, a difference occurs in positions of the silicon structure after the EMC molding process, and a high process temperature is required in order to perform the EMC molding process.

Further, a volume of a space part for driving of the driving body is very important in determining driving characteristics. However, an optimal design for driving of the driving body is not implemented, such that a sensor design according to damping or high speed driving of the driving body may not be implemented.

In order to solve these problems, the sensor may be covered using a cap. However, when the cap is coupled, the cap is separated due to air expansion within the cap, such that a defect is generated. In order to solve this problem, an upper portion of the cap is pressed using a load block, a manufacturing process of the sensor is complicated.

### SUMMARY OF THE INVENTION

The present invention has been made in an effort to provide an inertial sensor of which a cap or a printed circuit board is provided with an air discharging hole for discharging internal air to the outside, such that a bonding defect of the cap caused by air expansion within the cap when the cap is coupled to the printed circuit board in the prior art may be previously prevented, a manufacturing process may be simplified through omission of a process of pressing the cap using a load block for a predetermined time in order to fix the cap, and an environment within the inertial sensor that is sensitive to air action such as air damping, or the like, may be optimized.

According to a first preferred embodiment of the present invention, there is provided an inertial sensor including: a sensor part including a driving body, a flexible substrate part displaceably supporting the driving body, a support part supporting the flexible substrate part so that the driving body is freely movable in a state in which it is floated, and a lower cap covering a lower portion of the driving body and coupled to the support part; an application specific integrated circuit (ASIC) including the sensor part stacked thereon and coupled thereto; a printed circuit board including the ASIC stacked thereon and coupled thereto and electrically connected to the sensor part and the ASIC by a wire; and a cap covering the sensor part and the ASIC and coupled to the printed circuit board, wherein the cap includes an air discharging hole formed in order to discharge internal air to the outside.

The air discharging hole may be formed to correspond to the center of an upper portion of the sensor part.

A plurality of air discharging holes may be formed to be symmetrical to each other at outer sides based on the sensor part.

The air discharge hole may be formed at a side part of the cap facing a side part of the sensor part.

The cap may include bonding parts formed to correspond to one surface of the printed circuit board, and a plurality of air discharging holes may be formed at equidistance so as to be symmetrical to each other over the bonding parts.

According to a second preferred embodiment of the present invention, there is provided an inertial sensor including: a sensor part including a driving body, a flexible substrate part displaceably supporting the driving body, a support part supporting the flexible substrate part so that the driving body is freely movable in a state in which it is floated, and a lower cap covering a lower portion of the driving body and coupled to the support part; an application specific integrated circuit (ASIC) including the sensor part stacked thereon and coupled thereto; a printed circuit board including the ASIC stacked thereon and coupled thereto and electrically connected to the sensor part and the ASIC by a wire; and a cap covering the sensor part and the ASIC and coupled to the printed circuit board, wherein the printed circuit board includes an air discharging hole formed in order to discharge internal air of the cap to the outside.

According to a third preferred embodiment of the present invention, there is provided an inertial sensor including: a sensor part including a driving body, a flexible substrate part displaceably supporting the driving body, a support part supporting the flexible substrate part so that the driving body is freely movable in a state in which it is floated, and a lower cap covering a lower portion of the driving body and coupled to the support part; an application specific integrated circuit (ASIC) including the sensor part stacked thereon and coupled thereto; a printed circuit board including the ASIC stacked thereon and coupled thereto and electrically connected to the sensor part and the ASIC by a wire; and a cap covering the sensor part and the ASIC and coupled to the printed circuit board, wherein the lower cap includes a bonding part and a space part formed thereon, the bonding part being applied with a bonding agent in order to couple the lower cap and the support body to each other and the space part not being applied therewith, and internal air of the sensor part is discharged to the outside by the space part.

The cap may further include an air discharging hole formed in order to discharge internal air to the outside.

The cap may be made of any one selected among a metal, a ceramic, and a polymer.

### BRIEF DESCRIPTION OF THE DRAWINGS

FIG. 1 is a schematic cross-sectional view of an inertial sensor according to a first preferred embodiment of the present invention;

FIG. 2 is a schematic cross-sectional view of an inertial sensor according to a second preferred embodiment of the present invention;

FIG. 3 is a schematic cross-sectional view of an inertial sensor according to a third preferred embodiment of the present invention;

FIG. 4 is a schematic cross-sectional view of an inertial sensor according to a fourth preferred embodiment of the present invention; and

FIG. 5 is a schematic cross-sectional view of an inertial sensor according to a fifth preferred embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, an inertial sensor according to preferred embodiments of the present invention will be described with reference to the accompanying drawings.

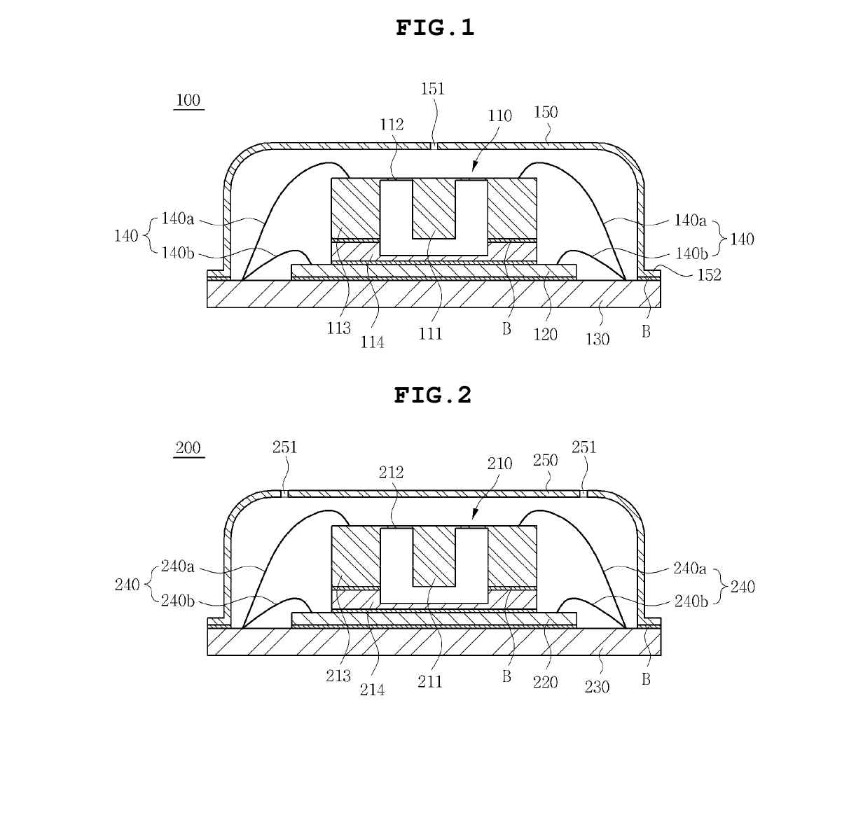

FIG. 1 is a schematic cross-sectional view of an inertial sensor according to a first preferred embodiment of the present invention. As shown, the inertial sensor 100 is configured to include a sensor part 110, an application specific integrated circuit (ASIC) 120, a printed circuit board 130, a wire 140, and a cap 150.

Here, the sensor part 110 includes a driving body 111, a flexible substrate part 112, a support body 113, and a lower cap 114.

More specifically, the flexible substrate part 112 includes a flexible substrate, a piezoelectric element (PZT), and an electrode, wherein the flexible substrate is formed of a silicon or silicon on insulator (SOI) substrate and includes driving electrode (not shown) and a sensing electrode (not shown) formed by depositing the piezoelectric element and the electrode thereon. The driving electrode is to drive the driving body, and the sensing electrode is to sense movement of the driving electrode to thereby detect inertial force.

In addition, the flexible substrate part 112 includes the driving body 111 displaceably coupled thereto, and the driving body 111 moves as voltage is applied to the driving electrode of the flexible substrate part 112.

Further, the support body 113 supports the driving body 111 and the flexible substrate part 112, and the driving body 111 is supported to be freely movable in a state in which it is floated by the support body 113.

In the sensor part 110 according to the preferred embodiment of the present invention, the driving body 111, the flexible substrate part 112, and the support body 113 may be formed integrally with each other by an etching process.

In addition, the lower cap 114 is to support and couple the sensor part to the ASIC 120 simultaneously with covering the driving body 111. Further, the lower cap 114 may be made of silicon that is the same material as the driving body 111 and the support body 113 or may be made of pyrex glass, etc., having a similar thermal expansion coefficient. However, it is preferable that the lower cap 114 is made of silicon that is the same material as the driving body 111 and the support body 113 in consideration of workability and process capability.

In addition, it is preferable that the lower cap 114 is coupled to the support body 113 by wafer level bonding and is formed in a low temperature process of 300□ or less in order to maintain characteristics of a piezoelectric thin film element, in consideration of process capability and economic efficiency. More specifically, the lower cap 114 is coupled to the support body 113 by polymer bonding using a photoresist or epoxy. As a result, a bonding part B is formed.

The sensor part 110 is configured as described above, the lower cap 115 of the sensor part 110 is stacked on and coupled to the ASIC 120, and the ASIC 120 is stacked on and coupled to the printed circuit board 130. In addition, the flexible substrate part 112 of the sensor part 110 is electrically connected to the printed circuit board 130 by a wire 140a, and the ASIC 120 is electrically connected to the printed circuit board 130 by a wire 140b.

Through the above-mentioned configuration, sensing and driving signals of the sensor part 110 are directly transferred to the printed circuit board 130, and the ASIC 120 and the printed circuit board are electrically connected to each other, such that signals are exchanged and processed therebetween.

In addition, the cap 150 is coupled to the printed circuit board 130 simultaneously with covering the sensor part 110, the ASIC 120, and the wires 140a and 140b. The cap 150 may be coupled to the printed circuit board 130 by polymer bonding using epoxy. As a result, a bonding part B is formed. In addition, the cap 150 may be made of various materials. However, it is preferable that the cap is made of a metal in consideration of durability, moisture resistance, and the like. Further, the cap 150 includes bonding parts 152 formed to be coupled to the printed circuit board 130 and corresponds to one surface of the printed circuit board.

In addition, the cap 150 may be made of any one selected among a metal, a ceramic, and a polymer.

In the inertial sensor according to the first preferred embodiment of the present invention, the cap 150 includes an air discharging hole 151 formed to correspond to a central portion of the sensor part 110. The air discharging hole 151 is to discharge air within the inertial sensor to the outside.

Through the above-mentioned configuration, the inertial sensor according to the first preferred embodiment of the present invention may previously prevent a bonding defect of the cap caused by air expansion within the cap when the cap is coupled to the printed circuit board in the prior art, simplify a manufacturing process through omission of a process of pressing the cap using a load block for a predetermined time in order to fix the cap, and optimize an environment within the inertial sensor that is sensitive to air action such as air damping, or the like.

FIG. 2 is a schematic cross-sectional view of an inertial sensor according to a second preferred embodiment of the present invention. As shown, the inertial sensor 200 is different only in a shape of a cap from the inertial sensor according to the first preferred embodiment of the present invention shown in FIG. 1.

More specifically, the inertial sensor 200 is configured to include a sensor part 210, an application specific integrated circuit (ASIC) 220, a printed circuit board 230, a wire 240, and a cap 250. Here, the sensor part 210 includes a driving body 211, a flexible substrate part 212, a support body 213, and a lower cap 214.

In addition, in the inertial sensor according to the second preferred embodiment of the present invention, the cap 250 includes a plurality of air discharging holes 251 formed at outer sides based on the sensor part 210 and symmetrical to each other. The air discharging holes 251 are formed at outer sides of an upper portion based on the sensor part 210. That is, the air discharging holes 251 are formed at an area in which there is a relatively large amount of air rather than an area corresponding to the sensor part, thereby making it possible to more efficiently discharge air.

FIG. 3 is a schematic cross-sectional view of an inertial sensor according to a third preferred embodiment of the present invention. As shown, the inertial sensor 300 is different only in a shape of a cap from the inertial sensor according to the first preferred embodiment of the present invention shown in FIG. 1.

More specifically, the inertial sensor 300 is configured to include a sensor part 310, an application specific integrated circuit (ASIC) 320, a printed circuit board 330, a wire 340, and a cap 350. Here, the sensor part 310 includes a driving body 311, a flexible substrate part 312, a support body 313, and a lower cap 314.

Further, in the inertial sensor according to the third preferred embodiment of the present invention, the cap 350 includes air discharging holes 351 formed to face side parts of the sensor part. More specifically, the cap 350 includes bonding parts 152 formed to be coupled to the printed circuit board 330 and correspond to one surface of the printed circuit board 330 and includes the air discharging holes 351 formed at the side parts thereof positioned over the bonding parts 352 and facing the side parts of the sensor part 310. In addition, a plurality of air discharging holes 351 are formed at equidistance so as to be symmetrical to each other.

Through the above-mentioned configuration, in the inertial sensor according to the third preferred embodiment of the present invention, the air discharging holes 351 are formed at areas in which there is a relatively large amount of air, thereby making it possible to more efficiently discharge air and discharge air while maintaining high durability against impact applied to the upper portion.

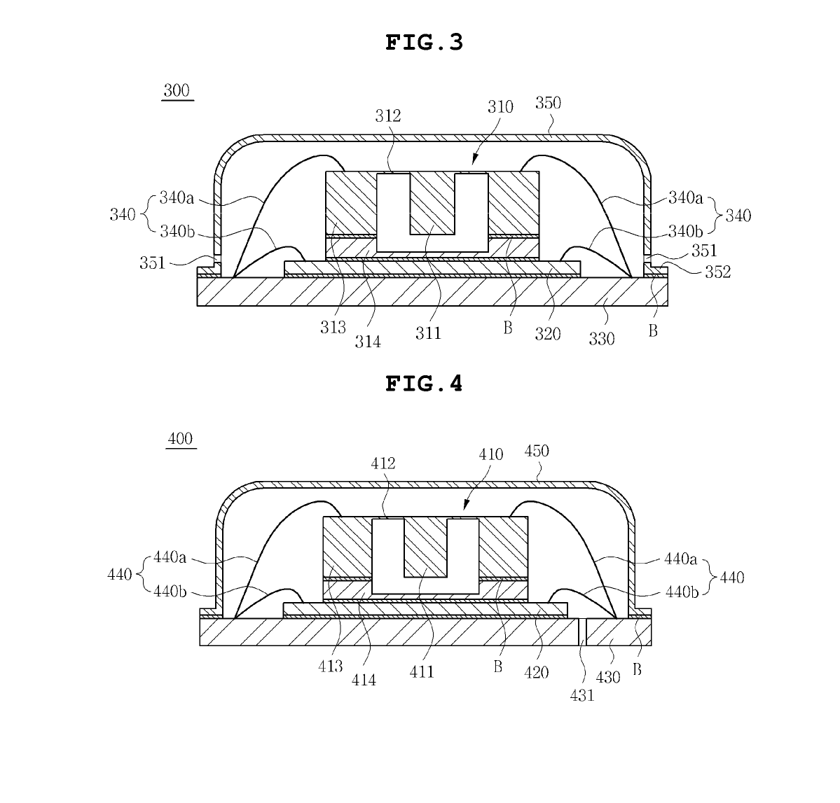

FIG. 4 is a schematic cross-sectional view of an inertial sensor according to a fourth preferred embodiment of the present invention. As shown, the inertial sensor 400 is different only in a shape of a printed circuit board from the inertial sensor according to the first preferred embodiment of the present invention shown in FIG. 1.

More specifically, the inertial sensor 400 is configured to include a sensor part 410, an application specific integrated circuit (ASIC) 420, a printed circuit board 430, a wire 440, and a cap 450. Here, the sensor part 410 includes a driving body 411, a flexible substrate part 412, a support body 413, and a lower cap 414.

In addition, in the inertial sensor according to the fourth preferred embodiment of the present invention, the printed circuit board 430 includes an air discharging hole 431 formed therein. Therefore, it is possible to more simply form the air discharging hole as compared to the inertial sensors according to the first to third preferred embodiments of the present invention in which the air discharging hole is formed in the cap and smoothly discharge air through the air discharging hole 431.

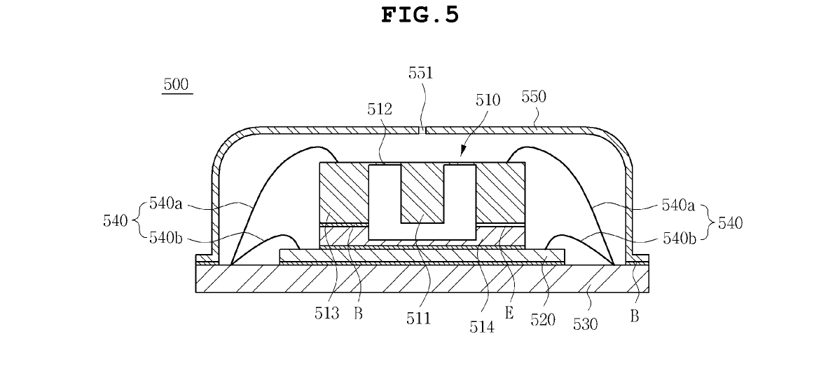

FIG. 5 is a schematic cross-sectional view of an inertial sensor according to a fifth preferred embodiment of the present invention. As shown, the inertial sensor 500 is different only in a coupling part between a lower cap and a support body from the inertial sensor according to the first preferred embodiment of the present invention shown in FIG. 1.

More specifically, the inertial sensor 500 is configured to include a sensor part 510, an application specific integrated circuit (ASIC) 520, a printed circuit board 530, a wire 540, and a cap 550. Here, the sensor part 510 includes a driving body 511, a flexible substrate part 512, a support body 513, and a lower cap 514.

In addition, in the inertial sensor according to the fifth preferred embodiment of the present invention, the lower cap 514 includes a bonding part B and a space part E formed thereon, wherein the bonding part B is formed for coupling the lower cap 514 and the support body 513 to each other and the space part E is not partially applied with a bonding agent. Further, air in the sensor part 510 may be discharged to the outside by the space part E. In addition, the air discharged from the sensor part 510 may be discharged to the outside of the inertial sensor 500 through an air discharging hole 551 of the cap 550.

Further, the inertial sensor according to the fifth preferred embodiment of the present invention may also be implemented so that the air discharging hole is not formed at a central portion of the cap but is formed as described in the second to fourth preferred embodiments of the present invention.

According to the preferred embodiments of the present invention, it is possible to obtain an inertial sensor of which a cap or a printed circuit board is provided with an air discharging hole for discharging internal air to the outside, such that a bonding defect of the cap caused by air expansion within the cap when the cap is coupled to the printed circuit board in the prior art may be previously prevented, a manufacturing process may be simplified through omission of a process of pressing the cap using a load block for a predetermined time in order to fix the cap, and an environment within the inertial sensor that is sensitive to air action such as air damping, or the like, may be optimized.

Although the embodiment of the present invention has been disclosed for illustrative purposes, it will be appreciated that an inertial sensor according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor comprising:
a sensor part including a driving body, a flexible substrate part displaceably supporting the driving body, a support part supporting the flexible substrate part so that the driving body is freely movable in a state in which it is floated, and a lower cap covering a lower portion of the driving body and coupled to the support part;
an application specific integrated circuit (ASIC) including the sensor part stacked thereon and coupled thereto;
a printed circuit board including the ASIC stacked thereon and coupled thereto and electrically connected to the sensor part and the ASIC by a wire; and
a cap covering the sensor part and the ASIC and coupled to the printed circuit board,
wherein the cap includes an air discharging hole formed in order to discharge internal air to the outside.

2. The inertial sensor as set forth in claim 1, wherein the air discharging hole is formed to correspond to the center of an upper portion of the sensor part.

3. The inertial sensor as set forth in claim 1, wherein a plurality of air discharging holes are formed to be symmetrical to each other at outer sides based on the sensor part.

4. The inertial sensor as set forth in claim 1, wherein the air discharge hole is formed at a side part of the cap facing a side part of the sensor part.

5. The inertial sensor as set forth in claim 1, wherein the cap includes bonding parts formed to correspond to one surface of the printed circuit board, and a plurality of air discharging holes are formed at equidistance so as to be symmetrical to each other over the bonding parts.

6. The inertial sensor as set forth in claim 1, wherein the cap is made of any one selected among a metal, a ceramic, and a polymer.

7. An inertial sensor comprising:
a sensor part including a driving body, a flexible substrate part displaceably supporting the driving body, a support part supporting the flexible substrate part so that the driving body is freely movable in a state in which it is floated, and a lower cap covering a lower portion of the driving body and coupled to the support part;
an application specific integrated circuit (ASIC) including the sensor part stacked thereon and coupled thereto;
a printed circuit board including the ASIC stacked thereon and coupled thereto and electrically connected to the sensor part and the ASIC by a wire; and
a cap covering the sensor part and the ASIC and coupled to the printed circuit board,
wherein the printed circuit board includes an air discharging hole formed in order to discharge internal air of the cap to the outside.

8. The inertial sensor as set forth in claim 7, wherein the cap is made of any one selected among a metal, a ceramic, and a polymer.

9. An inertial sensor comprising:
a sensor part including a driving body, a flexible substrate part displaceably supporting the driving body, a support part supporting the flexible substrate part so that the driving body is freely movable in a state in which it is floated, and a lower cap covering a lower portion of the driving body and coupled to the support part;
an application specific integrated circuit (ASIC) including the sensor part stacked thereon and coupled thereto;
a printed circuit board including the ASIC stacked thereon and coupled thereto and electrically connected to the sensor part and the ASIC by a wire; and
a cap covering the sensor part and the ASIC and coupled to the printed circuit board,
wherein the lower cap includes a bonding part and a space part formed thereon, the bonding part being applied with a bonding agent in order to couple the lower cap and the support body to each other and the space part not being applied therewith, and internal air of the sensor part is discharged to the outside by the space part.

10. The inertial sensor as set forth in claim 9, wherein the cap further includes an air discharging hole formed in order to discharge internal air to the outside.

11. The inertial sensor as set forth in claim 9, wherein the cap is made of any one selected among a metal, a ceramic, and a polymer.
